(19) United States
(12) Patent Application Publication
(10) Pub. No.: US 2011/0025434 A1
(43) Pub. Date: Feb. 3, 2011

(54) SIGNAL TRANSMISSION APPARATUS

(75) Inventors: PO-CHUAN HSIEH, Tu-Cheng (TW); YU-CHANG PAI, Tu-Cheng (TW); SHOU-KUO HSU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/620,558

(22) Filed: Nov. 17, 2009

(30) Foreign Application Priority Data
Jul. 30, 2009 (CN) 200910305017.7

(51) Int. Cl. H01P 1/203; H01P 3/08

(52) U.S. Cl. 333/204; 333/4

(57) ABSTRACT

A signal transmission apparatus includes two circuit layers. First and second ground sheets each has a rectangular area are arranged in the two circuit layers respectively. A third ground sheet is arranged between the two circuit layers. A differential pair includes a transmission line arranged between the first and third ground sheets and a transmission line arranged between the second and third ground sheets. The first to third ground sheets have same electric potential. Projections of the two rectangular areas on a surface where the third ground sheet in only have one common border with the third ground sheet. The third ground sheet is formed by extending the common border along a signal transmission direction. The differential pair includes a number of section pairs each composed of two sections arranged in the two transmission lines symmetrically. Every two adjacent section pairs are equivalent to a capacitor and an inductor.

### BACKGROUND

1. Technical Field

The present disclosure relates to signal transmission systems, and particularly to a signal transmission apparatus used in a signal receiver or a signal transceiver of a wireless transmission system.

2. Description of Related Art

Wireless transmissions are widely used in communications and networks. Consequently, electronic devices can be moved freely without limitations of wires when transmitting signals. In a wireless transmission system, a signal for transmission is modulated by a high frequency carrier in a signal transceiver to generate a radio frequency signal. The radio frequency signal is transmitted to a signal receiver via air, and is demodulated into the signal for transmission in the signal receiver. Bad signal quality may be induced if signal transmission paths of the radio frequency signal in the signal transceiver and the signal receiver are improperly designed.

### BRIEF DESCRIPTION OF THE DRAWINGS

FIG. 1 is an isometric view of a signal transmission apparatus according to an embodiment of the present disclosure, wherein the signal transmission apparatus includes a low pass filter, the low pass filter includes a plurality of section pairs of a differential pair.

FIG. 2 is a top view of the signal transmission apparatus of FIG. 1.

FIG. 3 is a top view of the low pass filter of FIG. 1, in which two sections in each of the section pairs are in mirror image.

FIG. 4 is an equivalent circuit diagram of the low pass filter of FIG. 1.

FIG. 5 shows another embodiment of the low pass filter of FIG. 1, in which there is a relative horizontal displacement between the two sections in some of the section pairs.

FIG. 6 is a simulation graph of insertion loss of a difference-mode input for the signal transmission apparatus of FIG. 1.

FIG. 7 is a simulation graph of insertion loss of a common-mode input for the signal transmission apparatus of FIG. 1.

### DETAILED DESCRIPTION

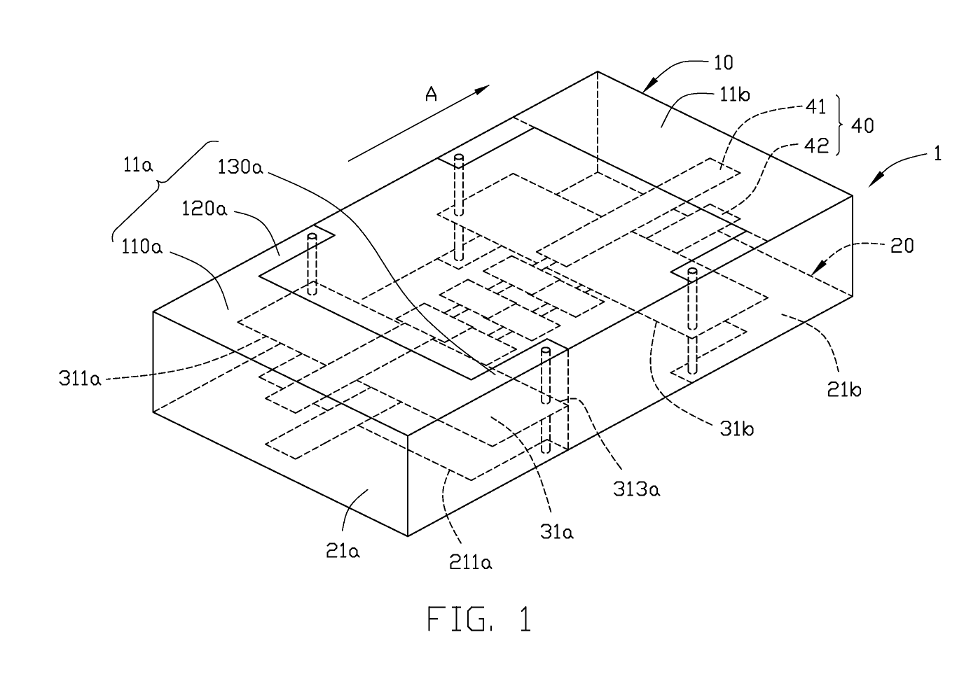

Referring to FIGS. 1 to 3, an embodiment of a signal transmission apparatus 1 is used in a printed circuit board. The apparatus 1 includes six ground sheets 11a, 11b, 21a, 21b, 31a, 31b, a differential pair 40, and four through holes 51, 52, 53, and 54. The ground sheets 11a, 11b, 21a, 21b, 31a, and 31b are parallel to each other. The ground sheets 11a and 11b are arranged in a first circuit layer 10. The ground sheets 21a and 21b are arranged in a second circuit layer 20. There is glass fiber epoxy resin (FR-4) material arranged between the first and second circuit layers 10 and 20. The ground sheets 31a and 31b are arranged in the FR-4 material between the first and second circuit layers 10, 20. The ground sheets 31a and 31b are symmetrically arranged on a common surface.

The ground sheets 11a, 11b, 21a, 21, 31a, and 31b are made of conductive material, such as copper. Each of the ground sheets 11a, 11b, 21a, and 21b is a “U” shaped structure.

The ground sheet 11a includes a rectangular area 110a, and two areas 120a, 130a extended toward the ground sheet 11b from two opposite sides of the rectangular area 110a respectively. Each of the ground sheets 11b, 21a, and 21b also includes a rectangular area and two extended areas. The ground sheets 11a and 11b are arranged symmetrically in the first circuit layer 10. The ground sheets 21a and 21b are arranged symmetrically in the second circuit layer 20. Projections of the ground sheets 11a and 21a on the second circuit layer 20 superpose the ground sheets 21a and 21b respectively.

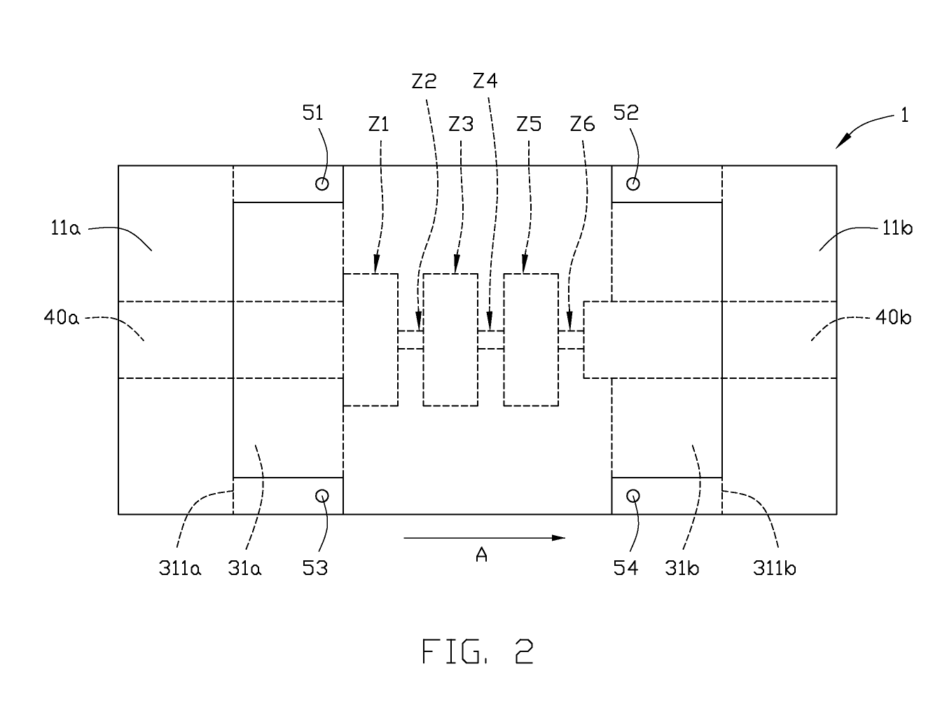

The ground sheets 31a and 31b are rectangular in shape. Projections of the rectangular areas of the ground sheets 11a and 21a on the ground sheet 31a superpose a border 311a of the ground sheet 31a. The ground sheet 31a is formed by extending the border 311a along a signal transmission direction indicated by the arrow A of FIGS. 1 and 2. Similarly, projections of the rectangular areas of the ground sheets 11b and 21b on the ground sheet 31b superpose a border 311b of the ground sheet 31b. The ground sheet 31b is formed by extending the second common border 311b along a direction opposite to the signal transmission direction.

The through hole 51 vertically passes through the extended area 120a, the ground sheet 31a and the corresponding extended area of the ground sheet 21a. The through hole 53 vertically passes through the extended area 130a, the ground sheet 31a and the other extended area of the ground sheet 21a. Each of the through holes 52 and 54 vertically passes through a corresponding extended area of the ground sheet 11b, the ground sheet 31b and a corresponding extended area of the ground sheet 21b. The ground sheets 11a, 21a, and 31a are conductively connected by the through holes 51 and 53. The ground sheets 11b, 21b, and 31b are conductively connected by the through holes 52 and 54. Therefore, the ground sheets 11a, 21a, and 31a have same electric potentials. The ground sheets 11b, 21b, and 31b have same electric potentials. In this embodiment, the ground sheets 11a, 11b, 21a, 21b, 31a, and 31b have same electric potentials.

The differential pair 40 transmits differential signals along the signal transmission direction A, and are parallel to the ground sheets 11a, 11b, 21a, 21b, 31a, and 31b. The differential pair 40 includes two transmission lines 41 and 42. The transmission line 41 is arranged between the first circuit layer 10 and the common surface of the ground sheets 31a, 31b. The transmission line 42 is arranged between the second circuit layer 20 and the common surface of the ground sheets 31a, 31b. A first vertical distance between the transmission line 41 and the ground sheet 31a is equal to a second vertical distance between the transmission line 42 and the ground sheet 31a. A third vertical distance between the transmission line 41 and the ground sheet 11a is equal to a fourth vertical distance between the transmission line 42 and the ground sheet 21a. The first to fourth vertical distances are all equal. A horizontal distance between the through hole 51 and the differential pair 40 is equal to a horizontal distance between each of the through holes 52-54 and the differential pair 40. In this embodiment, an input terminal 40a of the differential pair 40 is arranged between the ground sheets 11a and 21a, and an output terminal 40b of the differential pair 40 is arranged between the ground sheets 11b and 21b.

The differential pair includes a plurality of section pairs arranged between the input terminal 40a and the output terminal 40b. Each section pair includes a section arranged in the transmission line 41 and a section arranged in the transmission line 42. The two sections of each section pair are symmetrical with one another. Every two adjacent sections arranged in each of the transmission lines 41 and 42 are different in width.

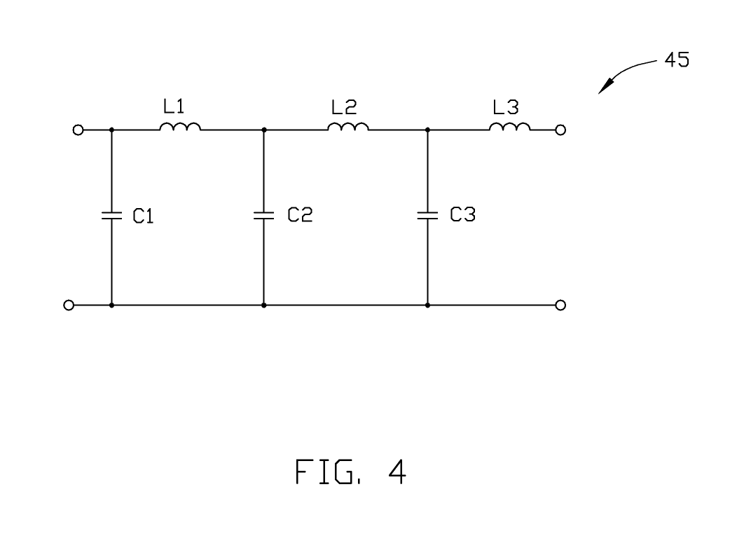

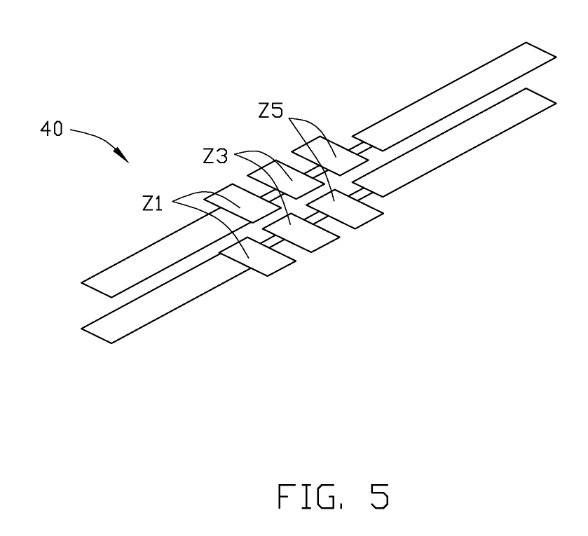

Referring to FIGS. 4-5, it is known in the art that both inductance and capacitance of a transmission line are related to the width of the transmission line; the inductance increases with decreasing line width, and the capacitance increases with increasing line width. Therefore, the section pairs which have wide line width function as capacitors, and section pairs which have narrow line width function as inductors. All of the section pairs form a low pass filter. The number of the section pairs is chosen by required specifications of the low pass filter. As illustrated in this embodiment, the differential pair 40 includes six section pairs Z1-Z6, which are designed according to a filter 45 as shown in FIG. 5.

The filter 45 includes three capacitors C1-C3 and three inductors L1-L3. The section pairs Z1, Z3, and Z5 are equivalent to the three capacitors C1-C3 respectively. The section pairs Z2, Z4, and Z6 are equivalent to the three inductors L1-L3 respectively. The line width of each section of each of the section pairs Z1-Z6 is determined by parameters of a corresponding equivalent capacitor or inductor. The parameters may include a capacitance of each of the capacitors C1-C3 correspondingly or an inductance of each of the inductors L1-L3.

The signal transmitted by the differential pair 40 is firstly affected by rectangular areas 110a, 120a of the ground sheets 11a, 21a. After that, the signal is affected by the ground sheet 31a. Because the ground sheet 11a, 21a, and 31a have the same electric potential, and projections of the rectangular area 110a and the rectangular area of the ground sheet 21a on the ground sheet 31a only have one common border with the ground sheet 31a, a continuous characteristic impedance of the differential pair 40 is obtained. Therefore, common mode noise is reduced during signal transmission. A signal with reduced noise is further filtered by the low pass filter formed by the section pairs Z1-Z6. As a result, signal transmission quality of the differential pair 40 is improved.

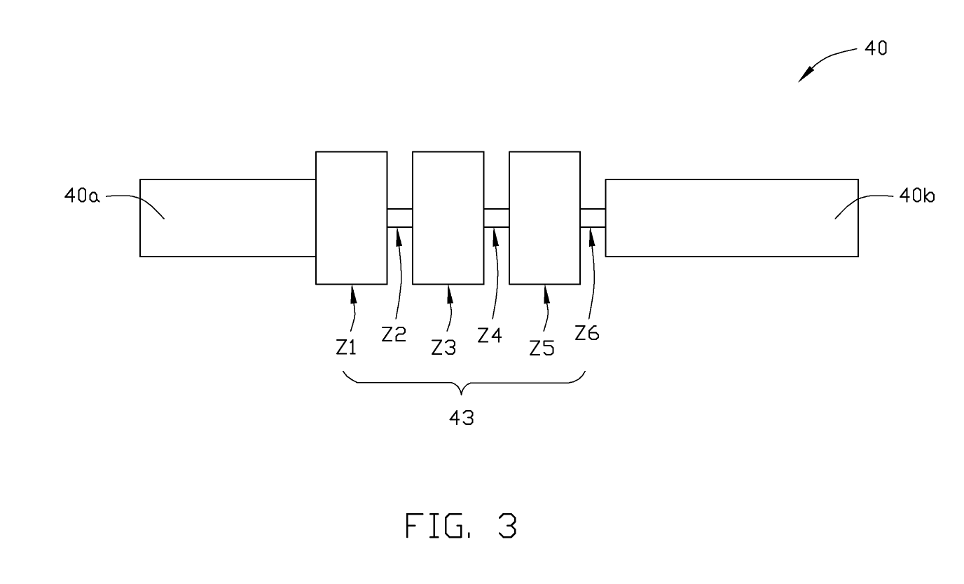

The transmission lines 41 and 42 are arranged at initial positions as shown in FIG. 3 that the transmission line 41 mirrors the transmission line 42. A frequency bandwidth of the differential pair 40 can be adjusted by changing a coupling capacitance between the sections of each of the section pairs Z1, Z3, and Z5. The coupling capacitance can be adjusted by moving the two sections of each of the section pairs Z1, Z3, and Z5 along the width of the transmission lines oppositely, from the initial positions respectively. In other words, the projection of the sections Z1, Z3, and Z5 of the transmission line 41 on the transmission line 42 is not superposed with the sections Z1, Z3, and Z5 of the transmission line 42.

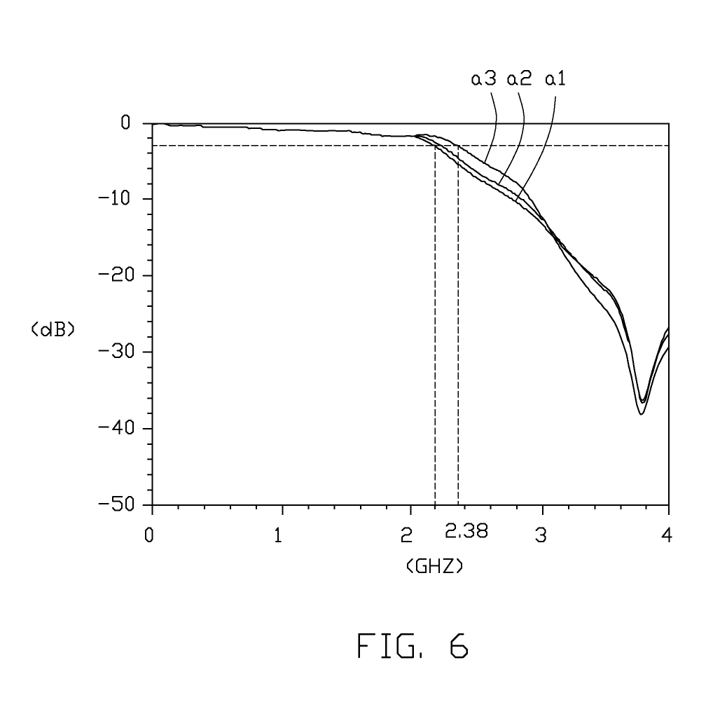

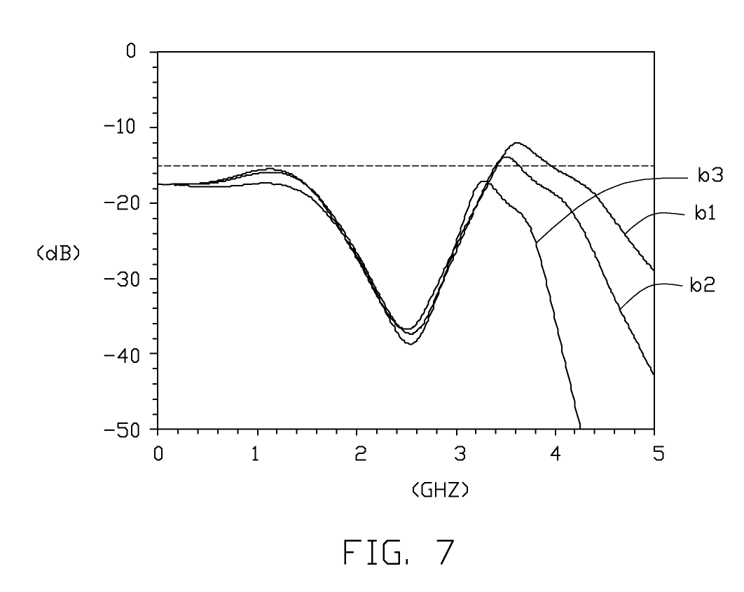

FIG. 6 is a graph showing an insertion loss of a difference-mode input for the differential pair 40. FIG. 7 is a graph showing an insertion loss of a common-mode input for the differential pair 40. Where a1 and b1 represent simulation results of the differential pair 40 in a condition that the transmission line 41 mirrors the transmission line 42; a2 and b2 represent simulation results of the differential pair 40 in a condition that 1.5 mm displacements of the two sections of each of the section pairs Z1, Z3, and Z5 are formed in opposite directions from the initial positions along the width of the transmission lines 41, 42; and a3 and b3 represent simulation results of the differential pair 40 in a condition that the displacements are 3 mm.

It can be determined from FIG. 6 that required frequency bandwidth of the differential pair 40 can be achieved at a gain of −3 dB, and the frequency bandwidth can be raised from 2.2 GHZ to 2.38 GHZ when the 3 mm replacements of the two sections of each of the section pairs Z1, Z3, and Z5 are formed in opposite directions from the initial positions along the width of the transmission lines 41, 42. A required performance of difference mode signal transmission is achieved in a frequency band from 0 GHZ to 3 GHZ since the corresponding gain values are close to zero. It can be determined from FIG. 7 that common noise can be suppressed efficiently in a frequency band from 0 GHZ to 5 GHZ since most of the corresponding gain values are less than −15 dB. As shown by the curve b3, the gain values of the loss of the common input for the differential pair 40 is less than −15 dB when the 3 mm displacements of the two sections of each of the section pairs Z1, Z3, and Z5 are formed in opposite directions from the initial positions along the width of the transmission lines 41, 42.

The differential pair 40 transmits signals in cooperation with the ground sheets 11a, 1ab, 21a, 21b, 31a and 31b. In other embodiments, the differential pair 40 can transmit signals without cooperating with the ground sheets 11b, 21b, and 31b. The signal transmission apparatus 1 can be used in wireless transmission devices, such as wireless network card and access point. The signal transmission apparatus 1 can also be used in wired transmission devices.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A signal transmission apparatus comprising:
a first ground sheet arranged in a first circuit layer of a printed circuit board, the first ground sheet comprising a first rectangular area;
a second ground sheet arranged in a second circuit layer of the printed circuit board, the second ground sheet comprising a second rectangular area having a same structure as the first rectangular area of the first ground sheet;
a third ground sheet arranged between the first and second circuit layers; and
a differential pair comprising a first transmission line and a second transmission line parallel to each other, wherein the first transmission line is arranged between the first and third ground sheets, the second transmission line is arranged between the second and third ground sheets; wherein
the first, second and third ground sheets have same electric potentials, and are parallel to a signal transmission direction of the differential pair, projections of the first and second rectangular areas on the third ground sheet superpose a border of the third ground sheet, the third ground sheet is formed by extending the border along the signal transmission direction, the differential pair comprises a plurality of section pairs, each of the plurality of section pairs is composed of two sections arranged in the first and second transmission lines symmetrically, every two adjacent section pairs are equivalent to a capacitor and an inductor.

2. The signal transmission apparatus of claim 1, wherein displacements of the two sections of each of the section pairs which are equivalent to capacitors are formed in opposite directions along the width of the first and second transmission lines, from an initial position where the first transmission line is projected on the second transmission line completely.

3. The signal transmission apparatus of claim 1, wherein a distance between the first and third ground sheets is equal to a distance between the second and third ground sheets, a distance between the first transmission line and the third ground sheet is equal to a distance between the second transmission line and the third ground sheet and a distance between the first and second transmission lines is twice as a distance between the first and third ground sheets.

4. The signal transmission apparatus of claim 1, wherein the first ground sheet further comprises a first extended area and a second extended area formed by extending along the signal transmission direction from two opposite sides of the first rectangular area, the second ground sheet further comprises a third extended area and a fourth extended area formed by extending along the signal transmission direction from two opposite sides of the second rectangular area.

5. The signal transmission apparatus of claim 4, wherein the first, second, and third ground sheets are electrically connected by a first and second through holes, the first through hole passes through the first extended area, the third ground sheet, and the third extended area vertically, the second through hole passes through the second extended area, the third ground sheet, and the fourth extended area vertically.

6. The signal transmission apparatus of claim 1, wherein there is glass fiber epoxy resin (FR-4) material arranged between the first and second circuit layers, the third ground sheet is arranged in the FR-4 material.

7. A signal transmission apparatus comprising:
a first circuit layer, a first ground sheet and a second ground sheet, each comprising a rectangular area, and being arranged in the first circuit layer;
a second circuit layer, a third ground sheet and a fourth ground sheet, each comprising a rectangular area and being arranged in the second circuit layer;
a fifth ground sheet and a sixth ground sheet arranged in a common surface between the first and second circuit layers; and
a differential pair comprising a first transmission line arranged between the first circuit layer and the common surface of the fifth and sixth ground sheets, and a second transmission line arranged between the second circuit layer and the common surface of the fifth and sixth ground sheets; wherein
the first to sixth ground sheets are parallel to a signal transmission direction of the differential pair, the first to sixth ground sheets have same electric potentials, projections of the rectangular areas of the first and third ground sheets on the fifth ground sheet superpose a first border of the fifth ground sheet, the fifth ground sheet is formed by extending the first border along the signal transmission direction, projections of the rectangular areas of the second and fourth ground sheets on the sixth ground sheet superpose a second border of the sixth ground sheet, the sixth ground sheet is formed by extending the second border toward the fifth ground sheet, the differential pair comprises a plurality of section pairs, each of the plurality of section pairs is composed of two sections arranged in the first and second transmission lines symmetrically, every two adjacent section pairs are equivalent to a capacitor and an inductor.

8. The signal transmission apparatus of claim 7, wherein an input terminal of the differential pair is arranged between the first and third ground sheets, and an output terminal of the differential pair is arranged between the second and fourth ground sheets.

9. The signal transmission apparatus of claim 8, wherein the plurality of section pairs are arranged between the input terminal and the output terminal of the differential pair.

10. The signal transmission apparatus of claim 7, wherein each of the first and second ground sheets further comprises two extended areas formed by extending along the signal transmission direction from two opposite sides of the corresponding rectangular area, each of the third and fourth ground sheets further comprises two extended areas formed by extending along an opposite direction of the signal transmission direction from two opposite sides of the corresponding rectangular area.

11. The signal transmission apparatus of claim 7, wherein a projection of the first ground sheet on the third ground sheet superposes the third ground sheet, a projection of the second ground sheet on the fourth ground sheet superposes the fourth ground sheet, the first to fourth ground sheets have same structures.

12. The signal transmission apparatus of claim 11, wherein the first, third, and fifth ground sheets are electrically connected by a first and a second through holes, the second, fourth, and sixth ground sheets are electrically connected by a third and a fourth through holes, each of the first and second through holes passes through an extended area of the first ground sheet, the fifth ground sheet, and an extended area of the third ground sheet vertically, each of the third and fourth through holes vertically passes through an extended area of the second ground sheet, the sixth ground sheet, and an extended area of the fourth ground sheet.

13. The signal transmission apparatus of claim 7, wherein the fifth and six ground sheets are symmetrically arranged in the common surface, and are rectangular in shapes.

14. A signal transmission apparatus in a printed circuit board (PCB) comprising:
two sets of ground portions symmetrically arranged, each set comprising:
a first ground sheet arranged in an upper circuit layer of the PCB;
a second ground sheet arranged in a lower circuit layer of the PCB; and
a third ground sheet arranged in a middle circuit layer of the PCB; wherein
the first and second ground sheets superpose each other, each of the first and second ground sheets has a border overlaps a border of the third ground sheet and extends an extended area to extend over the third ground sheet so that a through hole can only extend through the extended areas of the first and second ground sheets and the third ground sheet to even electric potentials of the three ground sheets;
a differential pair comprising a first transmission line and a second transmission line parallel to each other, wherein the first transmission line is arranged between the first and third ground sheets, the second transmission line is arranged between the second and third ground sheets; and wherein each of the first and second transmission lines comprises a signal input section overlapping with one of the two sets of ground portions, a signal output section overlapping with the other one of the two sets of ground portions, and a filter section connecting the input and output sections overlapping with an area between the two sets of ground portions to filter noise of transmission signals of the differential pair.

15. The signal transmission apparatus of claim 14, wherein the filter section comprises a plurality of sections connected in series, every two adjacent sections are different in width, the wider section acts as a capacitor and the narrower section acts as an inductor to form a low pass filter.
